(19) United States
(12) Patent Application Publication
(10) Pub. No.: US 2008/0279534 A1
(43) Pub. Date: Nov. 13, 2008

(54) Storage device for storing media and a playback device for playing back media

(76) Inventor: David B. Buttars, Park City, UT (US)

Correspondence Address: DAVID B. BUTTARS, 8774 GORGOZA DR, PARK CITY, UT, 84098, US

(21) Appl. No.: 12/150,229

(22) Filed: Apr. 25, 2008

Related U.S. Application Data
(60) Provisional application No. 60/914,280, filed on Apr. 26, 2007.
(60) Provisional application No. 60/914,282, filed on Apr. 26, 2007.
(60) Provisional application No. 60/914,283, filed on Apr. 26, 2007.
(60) Provisional application No. 60/914,286, filed on Apr. 26, 2007.

(51) Int. Cl. H04N 5/913

(52) U.S. Cl. 386/94; 386/E05.004

(57) ABSTRACT

This invention innovates storage, transport, and viewing of digital data utilizing a Portable Data Storage Device (PDSD) and playback device (PD). The associated process may involve a variety of methods to load and retrieve data employing a License Object to manage multiple, flexible parameters.

The user may dock the PDSD into the PD to connect a display (television, LCD panel, Projection Screens, etc.)

The PD may be embedded in a viewing device, or another PD, or be a stand-alone PD. The License Objects for Content stored on the PDSD are also backed up to ensure that if the user loses/damages the PDSD, the lost PDSD can be disabled in the system, and a new PDSD purchased by the user with the active License Objects loaded to the new PDSD, preserve the rights associated with those License Objects.

### CROSS-REFERENCE TO RELATED U.S. PATENT DOCUMENTS

This is a Regular Nonprovisional Utility Patent Application under 35 U.S.C section 111(a). The entire disclosure of prior application Ser. No. 11/161,271 filed Jul. 28, 2005 and published Jan. 10, 2008, Publication no.: US 2008/008456 A1 is herein incorporated by reference.

Additionally, the entire disclosures of previously filed Provisional Utility Patent Application per 35 U.S.C. 111(b), Nos. 60/914,280, 60/914,282, 60/914,283 and 60/914,286 inclusive.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

As used in this description and in the appended claims, the word ‘Content’ means; all digital data, including but not limited to motion pictures, audio, musical works, video, video games, multi-media, interactive media, data files, programs and other works stored as digital data files

1. Field of the Invention

The invention relates to a method and apparatus for storage and playback of video, audio, multi-media and other data recorded on non-volatile storage media.

2. Background

In the current video distribution industry, content is distributed in one of four basic methods; via theatrical release on either film-media or digital file, via optical disc on either DVD, HD-DVD, VCD or Blu-Ray Disc, via Cable Television services, and via internet service download or streaming. In all of these modalities, the consumer is faced with a balance of features and liabilities. These features and liabilities include variations in quality, portability, variety, additional features, ease of access, ease of use, viewing experience, personalization, and any number of other factors incumbent to the Content format, viewing apparatus, and Content delivery method.

Theatrical release has long held the quality high-ground, with 70 mm film and exceptional audio systems integrated into massive viewing arenas. The theater experience, while high in quality, is low on ease of access (limited viewing periods, locations, high costs), has minimal additional features, is low on variety, is completely lacking in portability, and to many the viewing experience is lacking due to the crowds often associated with theatrical releases, and the entire theater experience is quite impersonal. Trailers, promotions and advertisements are commonly associated with theatrical release, but are selected only based on broad, un-targeted demographic information and are thus relatively ineffective.

Optical discs are ubiquitous in today's video distribution industry, as they offer good quality (up to 1080p on Sony's Blu-Ray), are portable to anywhere a DVD player exists (homes, cars, boats, hotel rooms, computers, etc), have reasonable variety (over 600,000 titles exist as of 2007, and can hold any kind of data), have myriad additional features (additional scenes, alternate endings, games, behind the scenes footage, interviews, etc), have adequate access (approx 80,000 titles in rental circulation, over 250,000 available for purchase as of 2007) through retail sales and rental locations, can be used by the most technically inept users, viewing experience is variable based on the quality of the viewing venue (home theaters are widely varied, small personal DVD players provide minimal viewing experience), and personalization is nonexistent. Trailers, promotions and advertisements are commonly associated with optical discs, but are selected only based on broad, un-targeted demographic information and are thus relatively ineffective, and are often skipped by the viewer entirely. In some cases, the optical disc is restricted and requires the viewing of all trailers prior to starting the feature content, but in this case the onerous nature of the restriction makes the trailers an offensive element rather than an item of interest. As in 6,895,170, Lambert, et, al, some attempts have been made to include a variety of trailers and features on the optical discs so that any of a number of trailers may be seen each time the feature content is viewed, but again this data cannot be updated from user to user of the disc, and must be loaded to the optical disc at the time of manufacture based on broad, un-targeted demographic information.

Cable Television services have offered “on-demand” movie distribution, as well as a small amount of video game distribution for many years. Cable offers the same quality levels as optical discs, is largely not portable as it must be viewed from the cable box, has acceptable variety overall but on-demand selection is quite restricted, rarely includes any additional features, is accessible only to subscribers of a given cable service, has reasonable interface for most users but technically inept users often struggle with cable user interfaces, viewing experience is determined by the quality of the home viewing environment but is limited to the locations of the cable boxes, and has some potential for personalization through cable account usage tracking but the personalization is restricted to that particular cable service and account.

Internet distribution has been fraught with several issues first and foremost is the restriction due to overall capacity of the Internet infrastructure itself. The switching and routing capacity provided by the telecom providers is not capable of supporting wide-spread downloading of files the size of movies, particularly at higher definitions supported by DVD and Blu-Ray. As an example, Blockbuster Video rents on average approximately 40 million movies every Friday night. If these were suddenly converted to Internet downloads over that same 6-hour period, the data-load on the switching and routing infrastructure would literally bring the Internet to a grinding halt. This issue is not considered a permanent problem, but it will take many years to increase the capacity of the entire Internet infrastructure to accommodate these types of volumes. With this infrastructure restriction, high-quality content on par with DVD and Blu-Ray continues to be restricted to just a few users with exceptionally high-speed connections, portability is possible but is restricted to technically adept users with multiple devices to support the portability, the variety of content available on the internet is widely restricted to older low-value content due to piracy issues, the support of additional features is nearly non-existent on the internet, access is again limited to those willing to watch films on their computer or technically adept enough to integrate the multiple devices necessary to transmit the data from the computer to the TV or home theater, ease of use is limited due to the interface with both the computer and the web services where the data resides, viewing experience is again highly limited, and personalization, although possible, has minimal impact on the market due to small numbers of users willing to view movies on their computer.

### BRIEF SUMMARY OF THE INVENTION

The present invention comprises a method and apparatus for the storage, transport, and viewing of video, audio, multi-media, or other data using non-volatile storage media. One embodiment of the invention relates to a highly-portable, processor enabled, non-volatile storage device (Storage Device), and a corresponding processor enabled, playback device (Playback Device) used to store, move, and view digital video/audio programs or works (Content) of varying definitions and formats. The invention involves a manner of loading Content to a Storage Device, along with an highly flexible, associated License Object, that applies a variety of use parameters to the Content, including but not limited to permanent purchase, temporary use for a period of hours, days, weeks, months, or years, number of views, limitations on viewing windows, and virtually any other parameter that could be applied to the viewing of Content. At the expiry of the License Object, the processor on-board the Storage Device erases the Content, eliminating the need to return the Content as is necessary in the rental of DVDs or other optical storage media. In addition to the Content and License File, the Storage Device can be loaded with promotional data including, but not limited to, film trailers, advertisements, news programs, sports and music video files, and any other video, audio, multi-media, and other data. In one embodiment, the Storage Device may be associated with a specific user, and the data generated from its usage is aggregated to build a profile that is then applied to predictive algorithms that load trailers to the Storage Device specifically targeted to the Storage Device user. This same data may be used to load promotions and advertising that is highly targeted to the specific Storage Device user. Through continued use of the Storage Device, the user profile continues to build data and becomes more robust over time, creating highly detailed user data. In one embodiment, the user docks the Storage Device into the Playback Device, which in turn is connected to a viewing device including, but not limited to Televisions, LCD panels, Plasma Screens, Projection Screens, or any other viewing device compatible with, or that could be made compatible with the Playback Device. In one embodiment, two unique users may load the same Content file, and a series of trailers particular to each user is loaded to their Storage Device, resulting in completely different trailers being loaded in association with the same Content file, and thus creating unique viewing experiences for each user despite the fact they each loaded the same Content file. Similarly, a Storage Device user may elect to have any quantity of trailers loaded that are either self-selected or that are selected by a predictive algorithm that references the users' profile and, while viewing these trailers the user may select any number of them to be included in a queue for rental or purchase either at that moment or at a later time. In one embodiment, the playback device may be embedded in a viewing device, embedded in another type of Playback Device, or may be a Playback Device of its own. In one embodiment, the active License Objects for Content stored on the Storage Device are also backed up to the user-account at head-end of the system to ensure that if the user loses or damages the Storage Device, the missing or damaged Storage Device can be disabled in the system from the head-end, and a new Storage Device purchased by the user, and the active License Objects loaded to the new Storage Device, thus preserving the rights associated with those License Objects. In the manner described above, a user would have a nearly limitless variety of Content dynamically available to their Storage Device, the Storage Device would be highly portable, and may have trailers, promotions, and advertisements dynamically loaded to their Storage Device that are directly targeted to the user as a result of their usage patterns and profile, thus avoiding the distribution of trailers that are not of interest to the user, and/or advertising or promotions that are not germane to the user.

### BRIEF DESCRIPTION OF THE DRAWINGS

FIG. 1 is a block diagram of component architecture of the Storage Device that can be used with an embodiment of the invention.

FIG. 2 is a block diagram of component architecture of the Playback Device that can be used with an embodiment of the invention.

FIG. 3 is a block diagram of system architecture of all the elements of the system showing Content video files distributed to end-users in combination with the distribution of a system of Storage Devices, Playback Devices, and Kiosks used with an embodiment of the invention.

### DETAILED DESCRIPTION OF THE INVENTION

### Preferred Embodiment

The present invention comprises a method and apparatus for the storage and playback of video, audio, multi-media programs and other works from non-volatile storage media. One embodiment of the invention relates to a processor-enabled, non-volatile memory Storage Device used to distribute motion pictures and other audio/video data, programs or works. Storage Devices are distributed along with corresponding Playback Devices via a variety of retail channels, including but not limited to video rental stores, consumer electronics retail stores, kiosks, Internet retailers, and any other potential outlet for this type of product. At some point in the acquisition process, the user sets up a primary user account. In this account the user sets up the user profile for the first Storage Device, and for any subsequent Storage Devices assigned to this account. Each Storage Device may have the same or different user profiles assigned to them. Once the account is set up, the Storage Device may be loaded with Content data.

The primary Content data is loaded to the Storage Device by the user via a Storage Device-compatible Content library hosted and accessed from a variety of locations, including but not limited to the Internet via regional data centers, kiosks and user interface systems in video rental stores, retail stores, malls, and other areas where users may desire access to Content. These libraries may contain millions of Content titles giving the users access to an exponentially larger variety of viewing options than exist today. A user may browse the entire library, search on a variety of topics using meta-data attached to the Content files, or allow a predictive algorithm to suggest titles based on the profile of the user. In any of these cases, the user may view the trailer for that particular title, as well as read additional information on the title to help determine if the user will load that particular title. After the user selects a title to be loaded to the Storage Device, a License Object is generated and assigned to the Content file based on the viewing parameters selected by the user and is loaded along with the Content file. Available viewing parameters may be determined by the Content owner, distributor, retailer, or any combination of these entities and said parameters include but are not limited to permanent purchase, temporary use for a period of hours, days, weeks, months, or years, number of views, limitations on viewing windows, and virtually any other parameter that could be applied to the viewing of Content.

During this process, the computer controlling the Content library references the user profile associated with the Storage Device and selects trailers from a library of trailers that most closely fit that user profile. Similarly, advertising and promotions that closely fit the user profile may be selected from a library of advertisements and promotions and also loaded to the Storage Device. Additionally, the user may himself browse through the trailer libraries selecting any number of trailers for viewing later. During the viewing of these trailers, the user may select specific trailers for Content they wish to rent or purchase, and assign these titles to a “wish-list”, or, if the Playback Device from which they are viewing the Content is connected to the Internet and they are logged into an account with access to a Content library, they may choose to purchase a License Object and download the Content at that time.

In this embodiment, the usage data is logged to a usage data file on-board the Storage Device, and this file is backed up to the user account at the head-end of the system. This file grows over time, and becomes increasingly accurate at targeting the user's preferences. Thus, even though a user might rent the same Content file several times over the course of a few years, each time she rents that Content file, the trailers, advertisements and promotions that are loaded with that Content file will vary according to the evolution of the user profile. The user may be given the option to disable the predictive loading of trailers, in which case the Content owner's defaults would be applied to the Content file. The user may also be given the option to disable the loading of advertisements and/or promotions, in which case the Content owner's defaults would be applied to the Content file, or in the absence of defaults, none would be loaded. In either of these cases, the usage data would continue to be collected and aggregated to that account in case the user decided at some future time to enable the predictive algorithms.

In this embodiment, when the user desires to view the loaded Content, the user docks the Storage Device into a Playback Device. The Playback Device references the user profile and welcomes the user (if the user's name was David, it would bring up a splash screen with a greeting using David's name, and alerting him to the status of his Storage Device, including but not limited to the number of Content files on the Storage Device, the number of License Objects expired, or nearing expiration, any promotions applicable to the user based on the user's profile, and any other pertinent data as determined by the user or the system administrator) and then takes them to the most recently loaded Content file. The user manipulates the user interface via a remote control or via a face-mounted set of controls on the Playback Device itself. In either case, the user experiences a viewing experience parallel to the experience of navigating any current optical disc, with all of the current features and options.

In this embodiment, the Storage Device may store any new format or definition Content file, and the Playback Device may be updated to play any new format or definition. Updating of the Playback Device occurs via an update file that is loaded to every Storage Device at the same time the Storage Device docks to load content from any Storage Device-compatible library. When the Storage Device subsequently docks with a Playback Device, the update file is loaded to the Playback Device which is then updated with the new capabilities.

### DETAILED DESCRIPTION OF THE DRAWINGS

### Written Description Integrating the Drawings

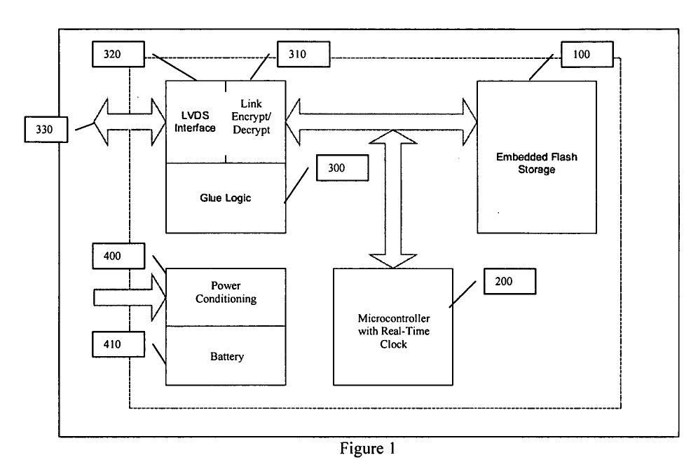

FIG. 1:

In one embodiment, the Storage Device is comprised of a Low Voltage Differential Signaling (LVDS) interface (320) connected to a multi-pin, board-to-board hardware interface (330). Content data is loaded to the Storage Device by transferring Content data across this LVDS interface (320) when the Storage Device is docked with a Content library hardware interface. This Content data transfer is controlled with embedded logic (300) processed by a Microcontroller (200), and after device authentication is verified by the Microcontroller (200) and embedded logic (300), a link decryption is applied (310) prior to moving the Content data to the Embedded Flash Storage (100). Content data is viewed through a Playback Device after the Storage Device is docked with a Playback Device using the board-to-board, multi-pin interface (330). The Microcontroller (200) again manages the authentication using the embedded logic (300), and the data is link encrypted (310) prior to transfer through the LVDS interface (320) and streamed to the Playback Device across the board-to-board, multi-pin interface (330). Each time the Storage Device is docked with either a Content library hardware interface, or a Playback Device, a power-pin from the board-to-board, multi-pin interface (330) takes power through a power conditioning chip (400), and then to the on-board Battery (410) which is in-turn charged until charge capacity is reached or the Storage Device is undocked.

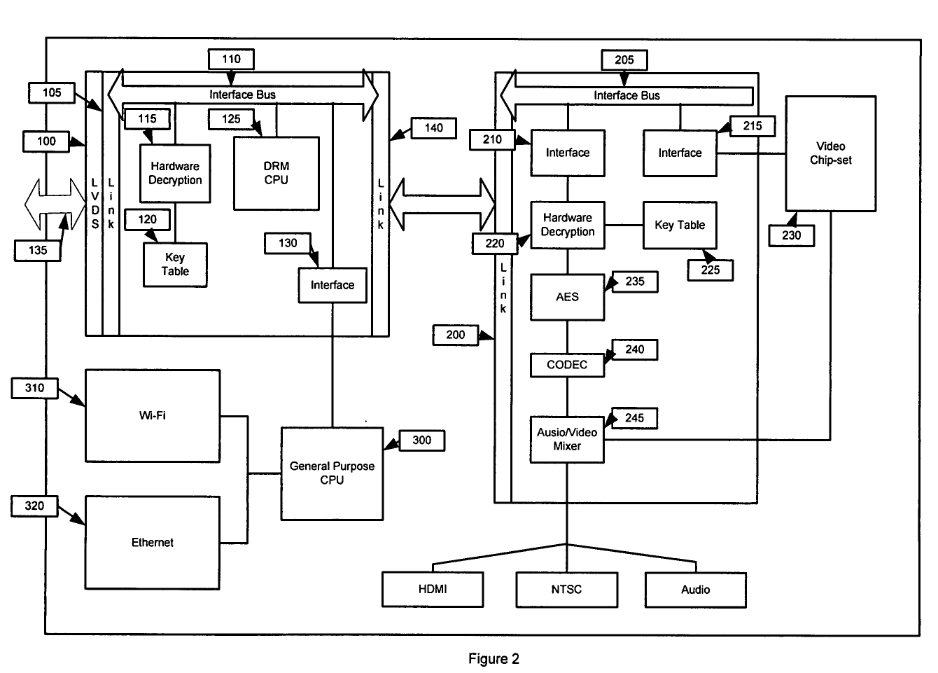

FIG. 2:

In one embodiment, the Playback Device is comprised of a Low Voltage Differential Signaling (LVDS) interface (100) connected to a multi-pin, board-to-board hardware interface (135). A secured processor (125) manages the authentication of a Storage Device when it docks using the multi-pin, board-to-board interface, and once authenticated, the user can initiate the viewing of Content stored on the Storage Device through a user interface managed by the general purpose processor (300). The user navigates through the user interface sending commands across a interface (130) to the secured processor (125) and selects a Content file for viewing, and both the Content data and the License Object data are then passed across the LVDS interface (100) where it is link decrypted (105), and moved across a interface bus (110) to a hardware decryption chip (115) where the encryption key of the License Object is verified against the on-board key table (120). Once verified and decrypted, the License Object data directs the CPU (300) to manage the permissions for viewing the Content data, and the still encrypted Content data is link encrypted (140) and transported for subsequent decryption, decoding and viewing. The Content data is link decrypted (200) and passed across the interface bus (205) through a interface (210) to a hardware decryption chip (220) where the encryption key of the Content data is verified against the on-board key table (225). Once verified the hardware encryption is decrypted, the Content data is then passed through the AES decryption engine (235) and through the decoding engine (240) for the applicable codec. The resulting Content data stream is then mixed with associated unencrypted ISO files which was passed through the interface (215) and the video chipset (230) and output through the appropriate I/O.

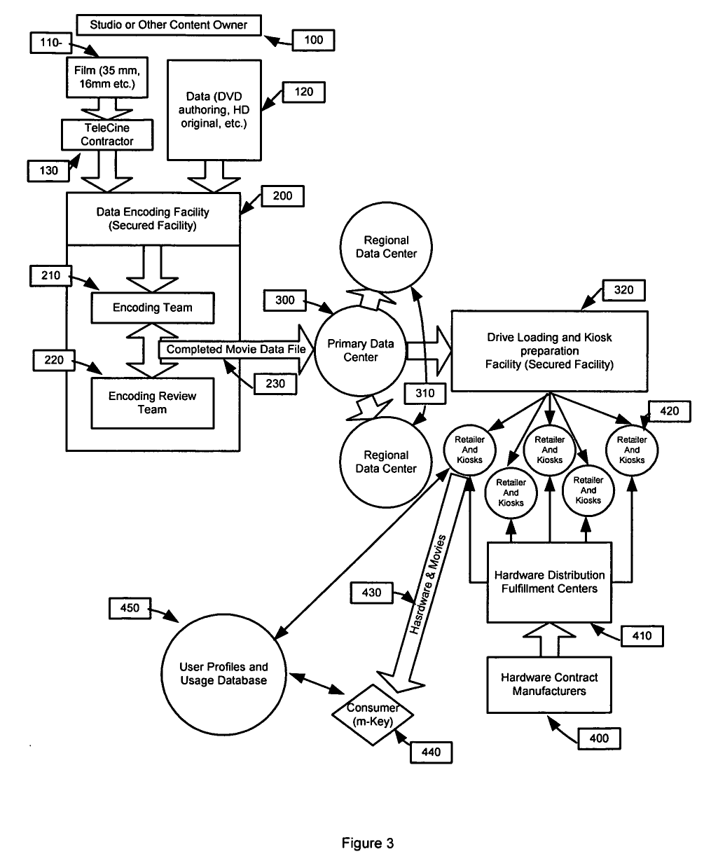

FIG. 3:

Content is received from a Studio or Content Owner (100) in either Film (110), or digital format (120). If received in film, it is converted to digital format through a Tele Cine service (130). Once the Content is in digital form, it is delivered to a secured Data Encoding Facility (200) where an Encoding Team (210) applies encoding to the Content, the encoding process is verified by an Encoding Review Team (220) and once certified, the Completed Data File (230) is delivered to the Primary Data Center (300), and subsequently Kiosk Drives (320) or to Regional Data Centers (310). Storage Devices and Playback Devices are manufactured at CEM facilities (400) and distributed through a variety of distribution relationships (410), to retail facilities (420), and from there to the Consumer (440) through a variety of retail channels (430). Data regarding customer use patterns, as well as any attempts at hacking the system are aggregated and tracked using Usage Databases (450), and that data is pushed back to the Kiosks (420) should a Storage Device show hacking patterns.

The preceding describes a method and apparatus for the storage, transport, and viewing of video, audio, multi-media, or other data using non-volatile storage media. Although the invention has been described with respect to certain example embodiments, it will be apparent to those skilled in the art that the present invention is not limited to these specific embodiments. Further, although the operation of certain embodiments has been described in detail using certain detailed process steps, some of the steps may be omitted, the steps may be performed in different sequences, or other similar steps may be substituted without departing from the scope of the invention. Other embodiments incorporating the inventive features of the invention will be apparent to those skilled in the art.

What is claimed is:

1. An apparatus for acquiring, storing, viewing, and retaining or disposing of digital Content stored on processor-enabled, non-volatile storage media, and a processor-enabled playback device for enabling the viewing of stored Content comprising:
(a) a highly-portable Storage Device containing processor-enabled, non-volatile storage media; and
(b) a processor-enabled Playback Device; and
(c) a License Object generator capable of associating License Objects with Content files and creating highly variable license parameters based on a plurality of requirements; and
(d) a method for monitoring the expiry of License Object and deleting Content associated with expired License Objects, such that the integral combination of storage device, playback device, license object generator and method of monitory expiry of license object acts as an apparatus for acquiring, storing, viewing and retain or disposing of digital content.

2. A system for acquiring, storing, viewing, and retaining or disposing of digital Content stored on processor-enabled, non-volatile storage media, and a processor-enabled playback device for enabling the viewing of stored Content comprising:
(a) a highly-portable Storage Device containing processor-enabled, non-volatile storage media; and
(b) a processor-enabled Playback Device; and
(c) a License Object generator capable of associating License Objects with Content files and creating highly variable license parameters based on a plurality of requirements; and
(d) a method for monitoring the expiry of License Object and deleting Content associated with expired License Objects, such that the integral combination of storage device, playback device, license object generator and method of monitory expiry of license object acts as a system for acquiring, storing, viewing and retain or disposing of digital content.

3. The method of claim 1 or 2, or a combination thereof, creating a user account at the head-end of the system, identifying the Storage Device through that account, specifying any number of a plurality of user preferences developing a user profile within that account.

4. The method of claim 1 or 2, or a combination thereof, loading Content data to the Storage Device from a Storage Device-compatible library containing a plurality of Content files, trailers, advertisements, promotions, and/or other data.

5. The method of claim 4 selecting from a plurality of formats, definitions, or other options relating to the quality of, definition of, and/or features available, on the Content file selected for loading to the Storage Device.

6. The method of claim 1 or 2, or a combination thereof, selecting any of a plurality of viewing parameters, including but not limited to time, session, or a combination thereof or any other parameter that could be applied to the viewing or use of the Content files, creating a License Object based on the selected viewing parameters and assigned to the associated Content files.

7. The method of claim 1 or 2, or a combination thereof, docking the Storage Device with a Playback Device and viewing the Content files in a similar fashion to the current method by which consumers currently view DVD-based Content, including but not limited to play, rewind, fast-forward, skip, chapter-select, increase/decrease volume, wide-screen view, view additional features, and any other options that are, or may yet become available to viewers of Content.

8. The method of claim 1 or 2, or a combination thereof, collecting usage data from the Storage Device at a pre-determined frequency, and logging the data in a data file on-board the Storage Device.

9. The method of claim 8 logging the usage data on-board the Storage Device and transferring that data to a database in the head-end of the system associated with that particular Storage Device.

10. The method of claim 8 referencing usage data during the loading of Content by a user, at a Storage Device-compatible Content library, and using a predictive algorithm to suggest Content, trailers, advertising, and/or promotions specifically applicable to the Storage Device user.

11. The method of claim 4 specifying a library of trailer files and assigning trailers specific Content files owned by the Content owner, based on the Storage Device user profiles held in the user account.

12. The method of claim 3 creating a user-group in the user account at the head-end of the system, and assigning any number of Storage Devices to that user-group within their account.

13. The method of claim 12 assigning the Storage Device to a user within the user-group, and creating specific profile rules assigned to that Storage Device, including but not limited to:
rating restrictions, content restrictions, transaction volume restrictions, assignment of payment types, regional restrictions, and/or any other type of account management profile deemed necessary by the account owner.

14. The method of claim 1 or 2, or a combination thereof, wherein at the expiry of a License Object associated to a Content file, a user elects to restore, modify, or manipulate the License Object based on parameters specified by the Content owner or distributor, thus enabling the user to extend a Content rental, purchase the Content, or make any other modification to or manipulation of the License Object that is, or becomes available to the user through the system.

15. The method of claim 1 or 2, or a combination thereof, prompting a user to restore, modify, and/or manipulate the License Object associated with that Content File based on parameters specified by the Content owner or distributor, thus enabling the user to extend a Content rental, purchase the Content, making any other modification or manipulating the License Object available to the user through the system.

16. The method of claim 15 wherein the Playback Device is connected to the Internet via a wireless data connection including but not limited to 802.11a, b, g, WiMAX, EV-DO, Bluetooth, or any other form of wireless connection currently available, or that may become available to the user.

17. The method of claim 15 connecting the Playback Device to the Internet via a wired data connection, including but not limited to: Cable, LAN, dial-up, Optical Fiber, and/or any other form of wired connection currently available, and/or that may become available to the user.

18. The Playback Device apparatus of claim 1 manufacturing the playback device as a multi-component module (MCM) made up of a variety of components assembled on a printed circuit board (PCB), including but not limited to one or more processors, one or more input/output (I/O) interfaces, one or more video chip-sets, one or more audio chip-sets, and/or one or more decoding engines.

19. The Playback Device apparatus of claim 18 comprising a variety of security structures including but not limited to: hardware decryption engines capable of decrypting previously encrypted Content and other data, key tables supporting said decryption engines, software security applications, and physical security methods and apparatuses as currently implemented or developed and implemented in the future.

20. The Playback Device apparatus of claim 1 manufacturing the Playback Device as an Application Specific Integrated Circuit (ASIC) and/or other compatible technology.

21. The Playback Device apparatus of claim 20 embedding the Playback Device in any of a variety of other devices, including but not limited to: Cable TV boxes, Satellite TV boxes, Optical Disc players, Televisions, LCD panels, Plasma screens, computer monitors, hand-held devices, and/or any other devices currently used, or that may be developed and/or used in the future to view Content.

22. The Storage Device apparatus of claim 1 manufacturing the Storage Device as an MCM made up of a variety of components assembled on a PCB, including but not limited to: one or more processors, one or more I/O, one or more non-volatile memory structures, and/or one or more disk controllers.

23. The Storage Device apparatus of claim 22 manufacturing the Storage Device as an ASIC and or other compatible technology.

24. The method of claim 1 or 2, or a combination thereof, updating the Playback Device with increased capabilities, repair bugs, deficiencies, and/or any other update necessary to maintain full functionality of the Playback Device with all currently available formats and definitions of Content files during the life of the Playback Device, where the update is completed by transferring update files from the head-end system to the Storage Device-compatible Content libraries, and next to the Storage Device at the time of loading Content for viewing, and finally to the Playback Device while docking the Storage Device with the Playback Device for viewing of content, such that the entire process is invisible to the user.

25. The method of claim 24 wherein Playback Devices, Content Library computers, and Storage Devices are excluded from the entire system due to loss, theft, or tampering, via a data file which is transmitted in a viral fashion from the head-end through the Content libraries to all Storage Devices and Playback Devices as follows,
(a) as an initial sequence:
(i) a Storage Device, Playback Device, and/or Content Library interface device needing to be disabled in the system due to loss, theft, or tampering; and/or
(ii) the device is reported by a user to be lost or stolen; and/or
(iii) the owner(s) of a security system observe the tampering of a device; and/or,
(b) as a secondary sequence:
(i) the device's internal identification is communicates throughout the system from the head-end system via a viral file transferring from the head-end to the Content libraries, to Storage Devices, to the Playback Devices; and/or.
(ii) in the case where Playback Devices connect to the Internet, via file transferring directly from the head-end to the Playback Devices.
